(19) United States
(12) Patent Application Publication
(10) Pub. No.: US 2019/0269985 A1
(43) Pub. Date: Sep. 5, 2019

(54) SHAFT LOCK FOR LACROSSE STICK HANDLE AND HEAD

(71) Applicants: Michael Schmittdiel, Baltimore, MD (US); John Vajda, Stewartstown, PA (US)

(72) Inventors: Michael Schmittdiel, Baltimore, MD (US); John Vajda, Stewartstown, PA (US)

(21) Appl. No.: 16/389,656

(22) Filed: Apr. 19, 2019

Related U.S. Application Data
(63) Continuation-in-part of application No. 15/006,853, filed on Jan. 26, 2016, now abandoned.
Application No. 15/006,853 is a continuation-in-part of application No. 14/270,790, filed on May 6, 2014, now Pat. No. 9,579,551.
Application No. 14/270,790 is a continuation-in-part of application No. 13/561,640, filed on Jul. 30, 2012, now abandoned.
(60) Provisional application No. 62/107,693, filed on Jan. 26, 2015.

(51) Int. Cl. A63B 59/20; F16B 7/18; A63B 60/08

(52) U.S. Cl. CPC A63B 59/20; A63B 2102/14; A63B 60/08; F16B 7/182

(57) ABSTRACT

A shaft lock for interconnection of an elongate tubular lacrosse handle and a plastic lacrosse head. In a first embodiment, the shaft lock comprises an elastomeric insert compression-fitted inside the handle. The insert has a compressible body portion which, in an uncompressed form generally conforms to the interior walls of the handle and is defined by a plurality of co-planar ribs that span the interior walls of the handle and a hard screw-anchor embedded within the elastomer insert. In additional embodiments, the shaft lock comprises a collared male plug removably or integrally formed within said lacrosse head for joining said head to a hollow lacrosse handle. The collar surrounds the core plug such that a gap exists between the core plug and the collar for receiving the wall of said handle. The core plug may comprise four or more rotationally-symmetric ribs to correspond to one or more interior shapes of said handle. Said ribs may be formed in whole or in part of a resilient elastomeric material for compression fit of the handle between the plug and the collar of the shaft lock. The plug may be further anchored inside said handle by at least one screw threaded through the handle into the core plug. This avoids loosening and/or dislodgement as a result of impact or vibration, and resists the threads of the screw from stripping either the handle wall(s) or the insert as a result of torque or other stress.

### CROSS-REFERENCE TO RELATED APPLICATION(S)

The present application is a U.S. continuation-in-part Application of U.S. patent application Ser. No. 15/006,853 filed Jan. 26, 2016 which derives priority from U.S. Provisional Application No. 62/107,693 filed 26 Jan. 2015, and is a continuation-in-part of U.S. patent application Ser. No. 14/270,790, filed 6 May 2014, which is a continuation in part of U.S. patent application Ser. No. 13/561,640, filed 30 Jul. 2012.

### BACKGROUND OF THE INVENTION

### 1. Field of the Invention

The present invention relates generally to sports equipment and more particularly, to an improved shaft lock for interconnection between the handle and head of a lacrosse stick.

### 2. Description of the Background

In 1970, the introduction of double-wall, synthetic lacrosse heads revolutionized the game of lacrosse. In comparison to the traditional wooden single-wall heads, the synthetic heads imparted a lightness, maneuverability, and flexibility never-before experienced by lacrosse players. These performance advantages greatly enhanced players' skills such as throwing, catching, cradling, and scooping, and brought the sport of lacrosse to new levels of speed and excitement.

FIG. 1 illustrates a conventional molded-head lacrosse stick. As shown, a typical lacrosse stick includes a handle or shaft 20 (dashed lines) and a double-wall synthetic head 10. Head 10 includes a generally V-shaped frame having two sidewalls 14A, 14B joined by a socket 11 at the end narrow end of the “V” for receiving and seating the shaft 20. A transverse wall (or “scoop”) 16 joins the sidewalk 14A, 14B at the open end of the “V.” Webbing is woven between the sidewalls 14A, 14B, scoop 16 and stop member 18 to form a pocket. The “double-wall” descriptor applied to the head 10 refers to the fact that it has two sidewalk as opposed to the single sidewall found in traditional wooden lacrosse sticks in which the pocket is completed by a woven gut wall in place of a second, wooden sidewall. The shaft 20 joins the narrow end of the head 10 and is received in socket 11, which includes a stop member 18 defined by a closed-ended socket, and an outer throat 12 that may be supported by extensions of the sidewalls. The throat 12 and stop member 18 are conventionally integrally joined to form one unitary socket 11. Typically, a screw or other fastener 22 placed through stop member 18 secures the shaft 20 to head 10. The traditional double-wall head 10 is a monolithic structure that is injection-molded from synthetic materials such as nylon, urethane and polycarbonate as known in the art.

FIG. 2 illustrates a conventional injection molded goalie head comprising the same components as a field player's lacrosse stick illustrated in FIG. 1 but having a different overall shape due to its generally larger dimensions.

The typical features of a lacrosse stick are shown generally in Tucker et al., U.S. Pat. No. 3,507,495, Crawford et al., U.S. Pat. No. 4,034,984, and Tucker et al., U.S. Pat. No. 5,566,947, which are all incorporated by reference herein.

The traditional double-wall synthetic head is an injection-molded, monolithic structure. Examples of suitable synthetic materials well known in the art include nylon, polypropylene (PP), polyethylene (PE), amorphous polar plastics (e.g., polycarbonate (PC)), polymethylmethacrylate (PMMA), polystyrene (PS), high impact polystyrene (HIPS), polyphenylene oxide (PPO), glycol modified polyethylene terphthalate (PETG), acrylonitrile butadiene styrene (ABS), semicrystalline polar plastics (e.g., polyester PET and PBT), polyamide (e.g., Nylon 6 and Nylon 66), urethane, polyketone, polybutylerie terephalate, acetals (e.g., Delrin™ by DuPont), acrylic, acrylic-styrene-acrylonitrile (ASA), metallocene ethylene-propylene-diene terpolymer (EPDM) Nordel™ by DuPont), and composites. When first introduced, these materials were clearly superior to wood, offering players improved handling and durability. For example, a lacrosse head constructed of DuPont™ ZYTEL ST 801 nylon resin is able to withstand the bending and harsh impacts inherent to competition far better than a traditional wooden stick. As another example, a polycarbonate head, though having a flexibility similar to that of wood, is more structurally durable than wood and much lighter and, therefore, easier to maneuver when attached to a handle.

Ever since the plastic head was incorporated on competition lacrosse sticks in the 1970s, the plastic head has been attached to the handle with a simple screw connection, e.g., a “self-tapping” screw through the plastic head and handle (self-tapping screws cut their own threads).

The durability of that connection has long been an issue for several reasons. Repeatedly removing and re-assembling the components will eventually strip the hole and prevent stable assembly. In addition, the stresses on competition lacrosse sticks during play weakens the conventional connection inevitably to the point where the head sometimes loosens or even dislodges from the handle during play. Loosening or dislodgement can occur as the screw unscrews as a result of vibration, or as a result of the threads of the screw stripping from torque or other stress when no other forces are brought to bear to prevent these occurrences. The problem has grown acute due to the increasing use of lighter and thinner-walled handles. The thread engagement is often limited to two or fewer threads, causing excessive stress and instability of the head/handle connection. Stripping and loosening of the head/handle connection results. Further, when the handle is impacted, as frequently occurs during competitive play, the walls can compress or expand and the screw threads can strip. To combat these issues, players often resort to taping over the head/handle connection, but tape adds weight and is only a temporary fix, at best. Finally, like all athletes, lacrosse players are bigger and stronger than they have ever been, so pressures on the screw connection are increasing from the increased torque applied by stronger players.

Previous efforts to solve the head/handle connection problem have been ineffective. For example, U.S. Pat. No. 8,052,549 to Sykora discloses a non-resilient plug-like insert with a magnet for insertion into the handle. But the Sykora insert adds excessive weight and does not remain securely in position. Other advertised inserts devised for this same purpose have been of different constructions from the device disclosed by the Applicant and due to those constructions fail to satisfy the need for a more robust interconnection for the handle and head of a lacrosse stick to avoid loosening and head rattle.

References in this application to “competitive play”, “competitive sticks” and the like refer to lacrosse games and sticks that are subject to a governing body set of rules and regulations, such as the NCAA for men's lacrosse, US Lacrosse for women's lacrosse, the National Federation of State High School Association for much of high school lacrosse and variations adopted by individual private school and recreational leagues. Such terms do not refer to articles that have some or all of the basic components of lacrosse sticks (e.g. STX “Fiddle STX”) but which, due to their overall size, durability, etc. are not intended for use in competitive play.

### SUMMARY OF THE INVENTION

It is, therefore, an object of the invention to provide a robust, dual-material connection mechanism for the handle and head of a lacrosse stick that employs a hard plastic (e.g., Nylon) screw-anchor embedded in an elastomeric body that fits snugly within various inner handle dimensions.

It is another aspect of the present invention to provide a connection mechanism for the handle and head of a lacrosse stick that employs a collared male plug affixed to the lacrosse stick head and adapted to fit within the hollow bore of a lacrosse stick shaft. Both embodiments of Applicant's device and all other devices intended for the purpose of securing a lacrosse head/handle connection are hereinafter referred to as a “shaft lock.”

In accordance with the foregoing objects, the present invention is an improved shaft lock for interconnection of an elongate tubular lacrosse handle and a plastic head. In a first preferred embodiment, the shaft lock comprises an elastomeric insert compression-fitted inside the handle. The insert has a compressible body portion which, in an uncompressed form, generally conforms to the interior walls of the handle and is defined by a plurality of co-planar ribs that span the interior walls of the handle. A rigid screw-anchor is embedded within the elastomer insert, and the insert is anchored inside the handle by at least one screw threaded through the handle into the screw-anchor from top-to-bottom, the screw(s) engaging the screw anchor and compressing it against the elastomeric insert. The threaded engagement of the screw(s) through the wall of the handle and into the screw-anchor compresses the elastomeric insert, maintaining a constant tension against the screw(s) and against the interior walls of the handle. The screw-anchor optionally has a metal nut component to accommodate the screw(s). This interaction avoids loosening and/or dislodgement of the screws as a result of impact or vibration, and keeps the threads of the screw from stripping either the handle walls or the insert as a result of torque or other stress.

Further, the forces brought to bear by the compression of the plastic head onto the handle during assembly contribute to a more secure engagement since the head is attached to the handle over the handle segment containing the above-described attachment mechanisms.

In a second preferred embodiment, the shaft lock comprises a collared male plug integrally formed with a lacrosse head for joining the head to a hollow lacrosse stick shaft. The male plug is adapted to fit within the hollow bore of the lacrosse stick shaft. The male plug includes compressible members (e.g., ribs) that provide a snug friction fit with shafts having a range of different bore dimensions. In one preferred embodiment, the male plug includes a snubbed collar around the male plug that creates a gap between the collar and the male plug. This gap receives the wall of the lacrosse stick handle. To further secure the shaft, a fastener is preferably placed through an opening in the collar. Optionally, the shaft and possibly also the male plug have openings to receive the fastener, which are aligned with the opening in the collar.

In this configuration, the shaft is held securely in place by the friction fit of the male plug, the friction fit of the collar, and the fastener. The collared male plug therefore provides a significantly stronger connection in comparison to the simple male plug connections suggested by the prior art. In addition, the snubbed collar allows a player to place his hand closer to the center of gravity of the lacrosse head and ball, providing a better feel for stick handling and ball control.

In this second preferred embodiment, the compressible members on the male plug also provide a significant benefit. Many players purchase lacrosse stick shafts and heads independently and assemble custom sticks. For example, a player may prefer the head of one manufacturer and the shaft of another manufacturer, for cost or performance reasons. Players also frequently break lacrosse stick shafts and must replace them with different models or makes. To promote as many sales as possible, manufacturers tend to use uniform dimensions of the outside diameters of shafts and the corresponding female connections on the lacrosse heads. However, the inside dimensions of shafts can vary widely, due to different wall thicknesses, geometries, and shaft materials. For example, a titanium shaft would have a thinner wall than an aluminum shaft. The compressible members on the male plug help accommodate these varying inside shaft dimensions.

The present invention is described in greater detail in the detailed description of the invention, and the appended drawings. Additional features and advantages of the invention will be set forth in the description that follows, will be apparent from the description, or may be learned by practicing the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front view of a conventional lacrosse stick with handle 20 inserted in molded plastic head 10, and conventional (prior art) screw fastener 22 placed through opening 107 securing handle 20 to head 10.

FIG. 2 illustrates a conventional injection molded goalie head incorporating the same prior art components as the field player's lacrosse stick illustrated in FIG. 1, albeit with a different overall shape due to its generally larger dimensions.

FIG. 3 is a perspective view of an exemplary embodiment of the shaft lock 2 of the present invention inserted inside handle 20 according to a first embodiment of the present invention.

FIG. 4 is a perspective assembly view of the shaft lock 2 according to a first embodiment of the present invention.

FIG. 5 is a top view of the shaft lock 2 of FIG. 4 according to a first embodiment of the present invention.

FIG. 6 is an end view of the shaft lock 2 of FIGS. 4-5.

FIG. 7 is a side view of the shaft lock 2 of FIGS. 4-6.

FIG. 8 is a cross-section taken along the lines A-A of FIG. 7.

FIG. 9 is a top view of the anchor block 14 of FIG. 4.

FIG. 10 is a side view of the anchor block 14 of FIG. 9.

FIG. 11 is an end view of the anchor block 14 of FIGS. 9-10.

FIG. 12 is a cross-section of anchor block 14 taken along the lines A-A of FIG. 9.

FIG. 13 is a schematic diagram of an isometric view of an exemplary lacrosse head having a collared male plug 801, according to another embodiment of the present invention.

FIG. 14 is a front view of the lacrosse head 10 and male plug 801 of FIG. 13.

FIG. 15 is a top cross-sectional view of lacrosse head 10 having male plug 801 of FIGS. 13-14 along a longitudinal centerline of male plug 801.

FIG. 16 is a side cross-sectional view of lacrosse head 10 having male plug 801 of FIG. 13-15 along a longitudinal centerline of male plug 801.

FIG. 17 is a side view of a hexalobe-collared male plug 8 with lobes 803 having chamfered leading edges 808 and/or notches 809 to add more resiliency at the tips of lobes 803.

FIG. 18 is an end view of the hexalobe-collared male plug 8 of FIG. 17.

FIG. 19 is a side view of the hexalobe-collared male plug 8 with lobes 803 having more severely chamfered leading edges 808 to eliminate the need for notches 809.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is a shaft lock for interconnection between an elongate tubular lacrosse handle and a plastic head having a frame with a socket for insertion of the handle.

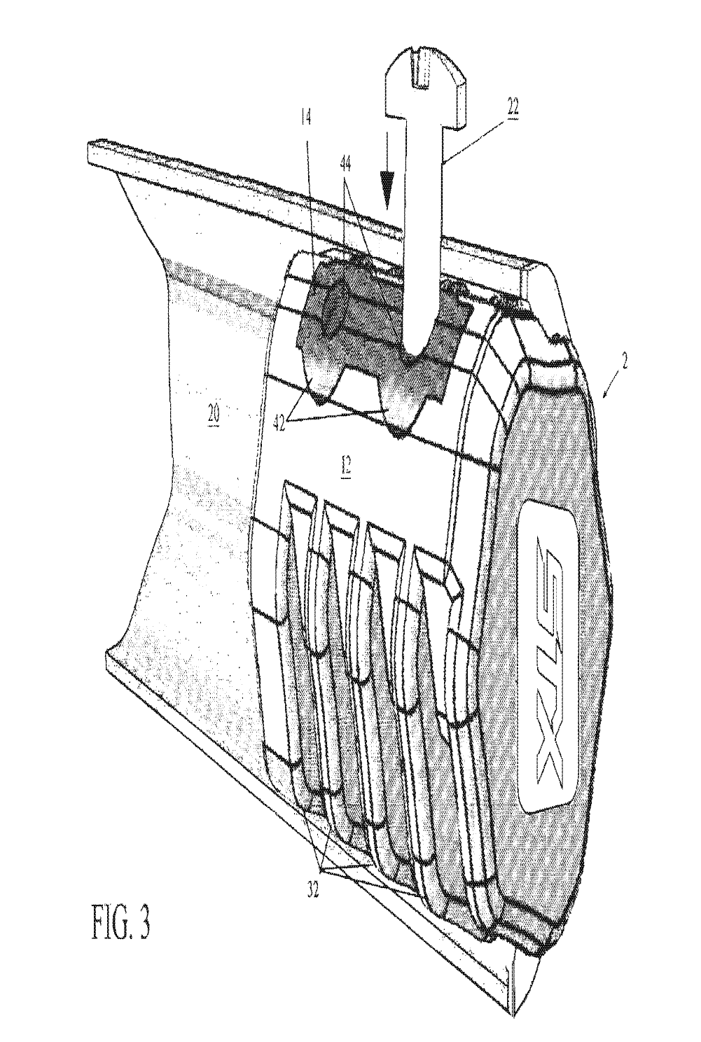

FIG. 3 is a perspective view of an exemplary embodiment of the shaft lock 2 according to a first preferred embodiment of the present invention, the shaft lock 2 generally comprising an over-molded dual-durometer insert compression-fitted inside the handle 20.

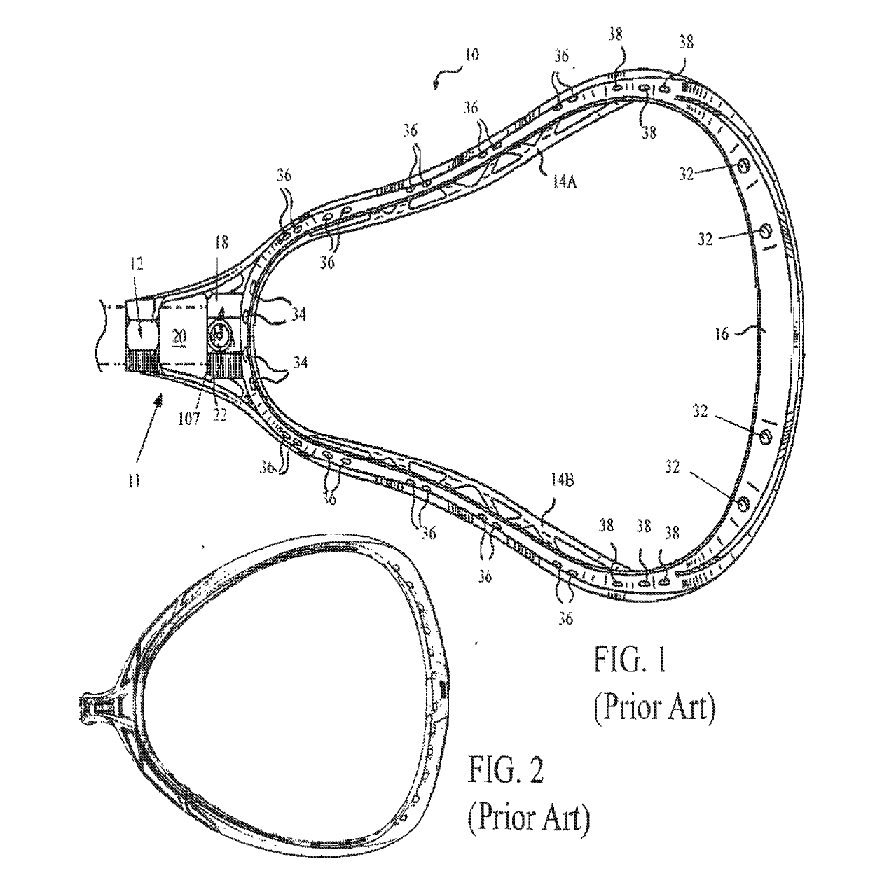

The elongate tubular lacrosse handle 20 may be any conventional tubular lacrosse handle such as a traditional octagonal cross-section formed of aluminum or composite materials. The plastic head 10 (see FIGS. 1-2) likewise has a traditional basket-frame with a socket at one end for insertion of the handle 20. The lacrosse handle 20 is fixedly attached inside the socket of the head using the shaft lock 2 of the present invention

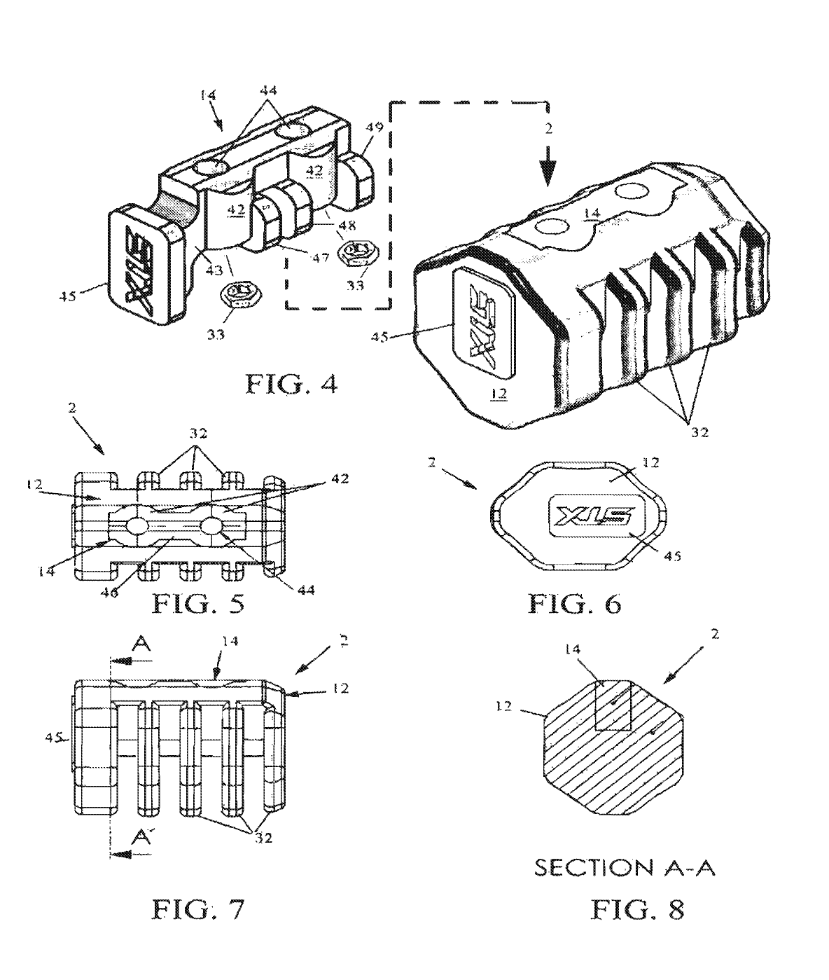

The shaft lock 2 has an elastomeric compressible body portion 12 which, in an uncompressed form generally conforms to the interior walls of the handle 20 and is sized for a close compression fit. A screw-anchor block 14 is embedded within the elastomeric body portion 12, and the shaft lock 2 anchors the handle 20 inside the socket by at least one and preferably two screws 22 threaded through the socket and handle 20 and into the anchor block 14 from top-to-bottom. The screw(s) 22 engage the anchor block 14 and compress it and the elastomeric body portion 12. The threaded engagement of the screw(s) 22 into the screw-anchor block 14 in combination with the resiliency of the elastomeric body portion 12 maintains a constant tension against the screw(s) 22. This avoids loosening and/or dislodgement of the screws 22 as a result of impact or vibration, and keeps the threads of the screw(s) 22 from stripping either the handle wall(s) or the insert as a result of torque or other stress. FIGS. 4-8 are side perspective, top, end and side views, respectively, of the shaft lock 2. With collective reference to FIGS. 4-8, the shaft lock 2 according to a first embodiment of the present invention generally comprises a unitary overmolded dual-durometer shaft insert having a relatively softer elastomeric body portion 12 and a harder anchor block 14 embedded inside the body portion 12. The shaft lock 2 is sized for a close compression fit into an end of the handle, prior to that end of handle 20 being inserted into the socket (as will be described). Body portion 12 is deformable, and in its normal form takes a shape generally confirming to a segment of the interior volume of handle 20. In a preferred embodiment of shaft lock 2 one end is slightly smaller than the other to ease insertion into the handle 20. This may be accomplished in a variety of ways, including with a slight, gradual inward taper of body portion 12 toward the smaller end or, alternatively, by rounding the edges of body portion 12.

As seen in FIGS. 5-6, the shaft lock 2 according to a first embodiment of the present invention is defined by top (FIG. 5), opposing ends (one shown in FIG. 6), and minor-image sides (FIG. 7). FIG. 8 is a cross-section taken along the lines A-A of FIG. 7. Preferably, the sides are formed with a plurality of equally-spaced grooves that define a series of laterally-and-downwardly protruding ribs 32. Ribs 32 are entirely formed in the elastomeric body portion 12 and serve two purposes: 1) ribs 32 have increased resiliency and a degree of lateral freedom, which increases both their shock-absorbing capability as well as their ability to conform to handles 10 of various sizes; and 2) ribs 32 provide increased lateral friction against the interior walls of handle 20 and resist slipping and dislodgment. Body portion 12 may be molded from any suitable elastomeric material as a matter of design choice preferably having a Young's Modulus within a range of from 10-100 MPa or 1,450-14,503 lbf/in² (psi). Body portion 12 is preferably over-molded onto the skeletal anchor block 14, which itself is formed of a material of higher durometer than body portion 12. In the presently-preferred embodiment anchor block 14 is formed of hard plastic, such as Nylon, having a Young's Modulus within a range of from 2000-4000 MPa or 290,000-580,000 lbf/in² (psi).

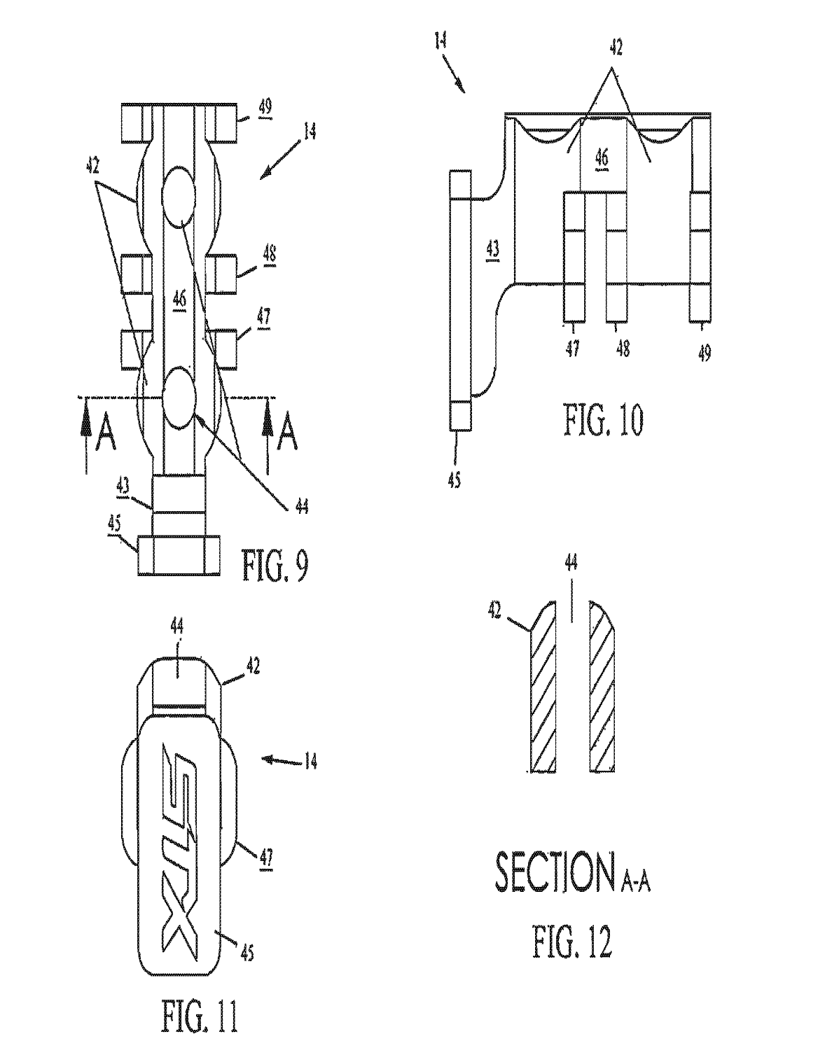

FIGS. 9-12 are a top view, side view, end view, and cross-section, respectively, of the anchor block 14 according to the fast embodiment of the present invention. Anchor block 14 is formed as a unitary molded component having at least one and preferably two (as shown) screw receptacles 42. Screw receptacles 42 are parallel semi-cylindrical members joined by a lateral crosspiece 46, and both screw receptacles 42 are defined by a preformed central through-hole 44 as shown. Anchor block 14 is flanked by four laterally-protruding flanges 45, 47 48 and 49 which extend outward past receptacles 42 on opposing sides at spaced intervals along the anchor block 14. A distal endwise flange 45 is extended and submerged slightly at the end of a leg 43, flange 45 presenting itself flat and substantially centered at an axis of the handle 20. The distal endwise flange 45 remains exposed from body portion 12 and bears a visible advertising indicia. When the shaft lock 2 is inserted in the handle 20 and the handle inserted into the socket, the distal flange 45 abuts the closed end of the socket, aligns the screw-holes, and serves as a foot to leg 43 to reinforce the position of the shaft lock 2. The collective flanges 45, 47, 48 and 49 serve two purposes, one being to anchor and position the anchor block 14 along its length inside the body portion 12, and the other being to serve as a reinforcing skeleton within the resilient body portion to thereby limit its resiliency and prevent tearing. Anchor block 14 may be molded separately and embedded within body portion 12 by a conventional over-molding process, or alternatively, by in-molding/co-molding or any other means known in the art suitable for embedding one object in another.

Referring back to FIG. 3, the two molded sleeves 42 and through-bores 44 passing through the anchor body 14 from top to bottom serve as screw-anchors. Both molded sleeves 42 may optionally include metal nuts 33 seated or embedded therein to receive the screws. Thus, the shaft lock 2 is first inserted endwise into the handle 20 until the distal endwise flange 45 is flush with the handle 10 orifice and the advertising indicia exposed from body portion 12 as shown. Two screws 22 are threaded through pre-chilled holes in the walls of the socket/handle 20 combination and into the through-bores 44. As the screw(s) 22 are tightened, with or without underlying nut(s), the shaft lock 2 is drawn against the handle 20 wall, thereby sandwiching and compressing the resilient body portion 12 but expanding is laterally. The distorted body portion 12 inside handle 20 locks the shaft lock 2 in place, reinforces the junction, and securely fixes the head on the handle 20.

If desired, the screw(s) 22 may be extended to engage nuts 33 at the bottom of anchor block 14. The combination of a threaded engagement of the screws 22 through handle walls 10 and through shaft lock 2, plus the compressive force of the screws 22 biasing the shaft lock 2 against the handle 20, effectively provides a more stable reinforcing collar inside the handle 20 along the distal tip that is inserted into the head. This helps to avoid loosening and/or dislodgement as a result of impact or vibration, and resists the threads of the screw stripping either the handle walls or the insert as a result of torque or other stress. Moreover, the receptacles 42 of the Nylon anchor body 14 have a high coefficient of friction and prevent counter-rotation and loosening of the screws 22. The machine screw(s) 22 can be conventional self-tapping screw(s) of a length calculated to extend at least partially through a majority of the anchor body 14 from top-to-bottom.

To assemble the shaft lock 2 according to this first embodiment of the present invention, the shaft lock 2 is placed inside the handle 20 with its through-bores 44 in axial alignment with both mounting holes in the handle 20 (as conventionally provided on commercial lacrosse stick handles). The lacrosse handle 20 is then inserted inside the socket of the head. The user inserts the screw(s) 22 through one wall of the socket of the head, and begins to thread it through the underlying wall of the handle 20 and into the shaft lock 2 using an appropriate implement such as a screw-driver or hex key. Tightening continues (optionally through the opposing wall of the handle 20), and through the other wall of the socket of the head 10, again optionally employing a nut beneath anchor block 14 as an anchor.

The foregoing securement of head to the handle 20 maintains a constant compressive force against the interior walls of the handle 20. This avoids loosening and/or dislodgement as a result of impact or vibration, and resists the threads of the screw stripping either the walls or the insert as a result of torque or other stress.

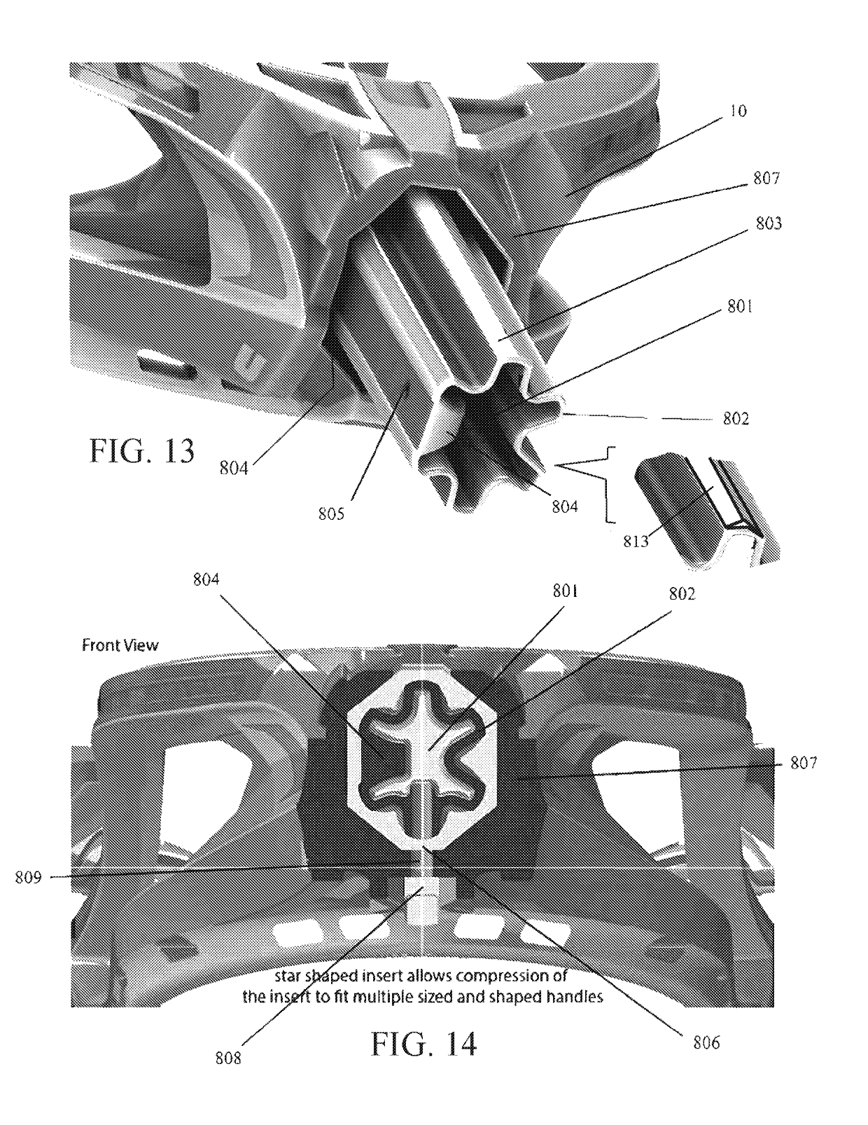

Another embodiment of a shaft lock according to the present invention comprises a collared male plug shown with reference to FIGS. 13-16. Generally, the collared male plug configuration was initially disclosed in U.S. Pat. Nos. 6,916,259 and 7,131,919 to Kohler, the disclosures of which are hereby incorporated by reference.

As best seen in FIG. 13 the collared male plug 8 configuration is generally disposed on the throat area of lacrosse head and includes a core 801 having a plurality of radially-protruding compressible members 803 that are adapted to fit within the hollow bore of a lacrosse stick shaft. Located around a portion of the length of core 801 and compressible members 803 is a collar 807 that creates a gap 812 into which the wall of the shaft slides. Although FIG. 13 illustrates a hexalobe-collared male plug 8 suitable for roughly octagonal-shaped shafts, it should be understood that a collared male plug according to the present invention could be adapted to fit any variety of shaft shapes, such as hexagonal-shaped shafts, tear-drop, asymmetrical, and oval, simply by altering the number of lobes. Indeed, the collared male plug of the present invention could be adapted to accommodate a cylindrical shaft or a shaft having any number of sides.

The illustrated core 801 is defined by a tubular outer wall 802. As seen in FIG. 14, a cross-section of core 801 forms a six-pointed “star” shape (e.g., hexalobe) wherein each point of the star is a lobe, denoted by reference character 803, and functions as a compression point to secure the handle 20 onto head 10A. As shown in the inset to FIG. 13, points 803 may contain a compressible member 813, preferably made of a different material than points 803, wherein the material forming compressible members 813 has a lower durometer than the material forming points 803 to enable a more snug, friction fit between plug 8 and handle 20. Examples of suitable materials to be used for core 801 include titanium, aluminum, nylon, polypropylene (PP), polyethylene (PE), amorphous polar plastics (e.g., polycarbonate (PC)), polymethylmethacrylate (PMMA), polystyrene (PS), high impact polystyrene (HIPS), polyphenylene oxide (PPO), glycol modified polyethylene terphthalate (PETG), acrylonitrile butadiene styrene (ABS), semicrystalline polar plastics (e.g., polyester PET and PBT), polyamide (e.g., Nylon 6 and Nylon 66), urethane, polyketone, polybutylene terephalate, acetals (e.g., Delrin™ by DuPont), acrylic, acrylic-styrene-acrylonitrile (ASA), metallocene ethylene-propylene-diene terpolymer (EPDM) (e.g., Nordel™ by DuPont), and composites.

According to a preferred embodiment of the present invention, collar 807 is approximately 0.712 inches long and male plug 801 is approximately 1.950 inches long. Core plug 801 is preferably about 0.874 inches wide as measured at maximum lateral width and about 1.062 inches wide as measured at maximum vertical width. The short length of collar 807 allows a player to hold shaft 20 as close as possible to the center of gravity of head 10 and a ball inside head 10. The preferred dimensions and shapes of male core plug 801 and its lobes 803 help maximize the strength of the connection between lacrosse head 10 and shaft 20. The compressible lobes 803 facilitate a tight friction fit inside shaft 20. In addition, compared to a solid plug fitted into the bore of shaft 20, the compressible lobes 803 and the shape of core plug 801 help reduce the weight so as not to affect the center of gravity of the overall head 10. For additional strength, the thickness of the stop member in throat area 12 can also be increased to, for example, 0.235 inches. Core 801 according to this embodiment of the present invention may be either permanently affixed to or integrally formed with lacrosse head 10 to enable head 10 to be securely attached to various shapes and sizes of lacrosse stick shafts 20, such as octagonal, such as tear-drop, asymmetrical, and oval shaped sticks. Alternatively, core 801 may be removable from head 10 to provide even more customization for players wishing to attach different sizes and types of lacrosse heads to different sizes and shapes of lacrosse stick shafts with a secure plug connection, and to have such connections be interchangeable as between various sizes and types of sticks and shafts as the player grows, changes abilities, preferences, or positions on the team. For this purpose, the collared male plug 8 inclusive of both core 801 and collar 807 according to the present invention may be manufactured in different diameters and/or with different numbers of points as described herein, or may be manufactured in a single, “standard” size and shape designed to be adaptable for use with many of the variations of head and shaft shapes described above.

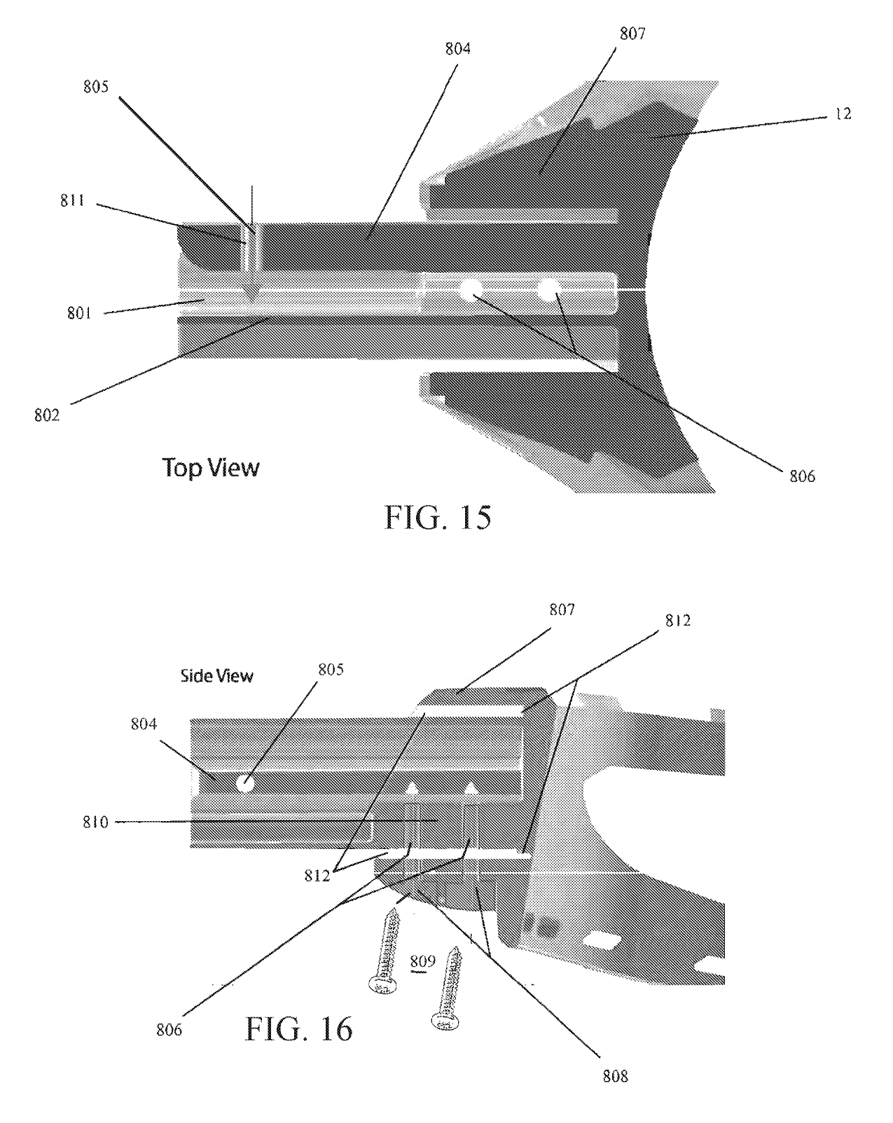

Further, and as best shown in FIGS. 13, 15 and 16, one side of the outer wall 802 forming core plug 801 has a greater wall thickness to form an integral screw block 804 with side screw hole 805 for optional attachment of core plug 801 to handle 20 as will be described herein. Side screw hole 805 is positioned within screw block 804 at the top of core plug 801 (left in FIG. 15), at a rotational position of ninety (90) degrees offset from one or more screw holes 806 located at the bottom of core plug 801. Screw holes 805, 806 may optionally attach care plug 801 to head 10, whereas plug 801 is otherwise removable from head 10. Front and side views, respectively, of the outer throat 12 of head 10 with screw holes 805, 806 are shown in FIGS. 15 and 16. In this embodiment core plug 801 is integrally formed with head 10, which further comprises integrally formed collar 807 extending from the throat area 12 of head 10 and up a portion of the length of core plug 801. Collar 807 preferably extends along at least that portion of core plug 801 containing screw holes 806 as shown in FIG. 15. Also as shown in FIG. 16, similar to screw block 804, one side of outer wail 802 of core plug 801 may be formed with a greater thickness in an area beneath collar 807 to define to second angularly-offset screw block 810 through which screw holes 806 are formed. As shown in FIGS. 15 and 16, screw holes 806 in core plug 801 align with two corresponding screw holes 808 in collar 807 to accommodate screws 809. In a preferred embodiment, screws 809 form one of two connections (the other being a screw inserted into side screw hole 805 as will be described) between head 10 and shaft 20. In an alternate, optional embodiment, core plug 801 is formed as a discrete component separate from head 10 and screws 809 secure the removable core plug 801 into a seat within collar 807 in head 10, and also serve as a connection point between head 10 and shaft 20.

The additional connection between head 10 and shaft 20, side screw hole 805, is also shown in FIGS. 15 and 16. As described above, side screw hole 805 is formed through a reinforced portion of outer wall 802 of core plug 801 comprising screw block 804. Screw hole 805 is sized and located to correspond with an opening in a standard lacrosse stick shaft of the types and shapes described above, preferably of the same size as screw hole 805. Thus, a screw (809, not shown) may be inserted through screw hole 805 and the corresponding hole in lacrosse stick shaft 20 to securely attach shaft 20 to head 10. To aid retention of the screw to be inserted through shaft 20 screw bole 805, screw hole 805 may be lined with an a layer of nylon 811, as shown in FIG. 15, to form a secure friction fit between the screw and screw hole 805. Similar nylon Inlets 811 may, if desired, be inserted into screw holes 806 as well.

Thus, to assemble, the lacrosse stick shaft 20 is inserted into the gap 812 between collar 807 and the base of core plug 801. Upon insertion, the end of shaft 20 abuts the bottom of the gap 812 between core plug 801 and collar 807. Then, screws 809 and side screw (not shown) may be inserted through screw holes 806/808 and 805, respectively, and through corresponding holes in shaft 20, to secure shaft 20 to head 10. Core plug 801 thus extends inside shaft 20 and down a portion of the length thereof, wherein points 803 provide a snug fit between core plug 801 and the interior surface of shaft 20. Alternately, in an optional embodiment wherein core plug 801 is not integrally formed with head 10, core plug 801 may be inserted into the hollow interior of shaft 20 and secured therein with a screw 809 placed through side screw hole 805 and a corresponding screw hole on the shaft 20 (not shown). Then, shaft 20, with core plug 801 secured in the interior of the end thereof, may be inserted into the recess formed in head 10 by integrally formed collar 807 and secured therein by screws 809 inserted through collar 207 (through screw hole 808), shaft 20, and core plug 801 (through screw hole 806) to secure head 10, shaft 20, and plug 801 together.

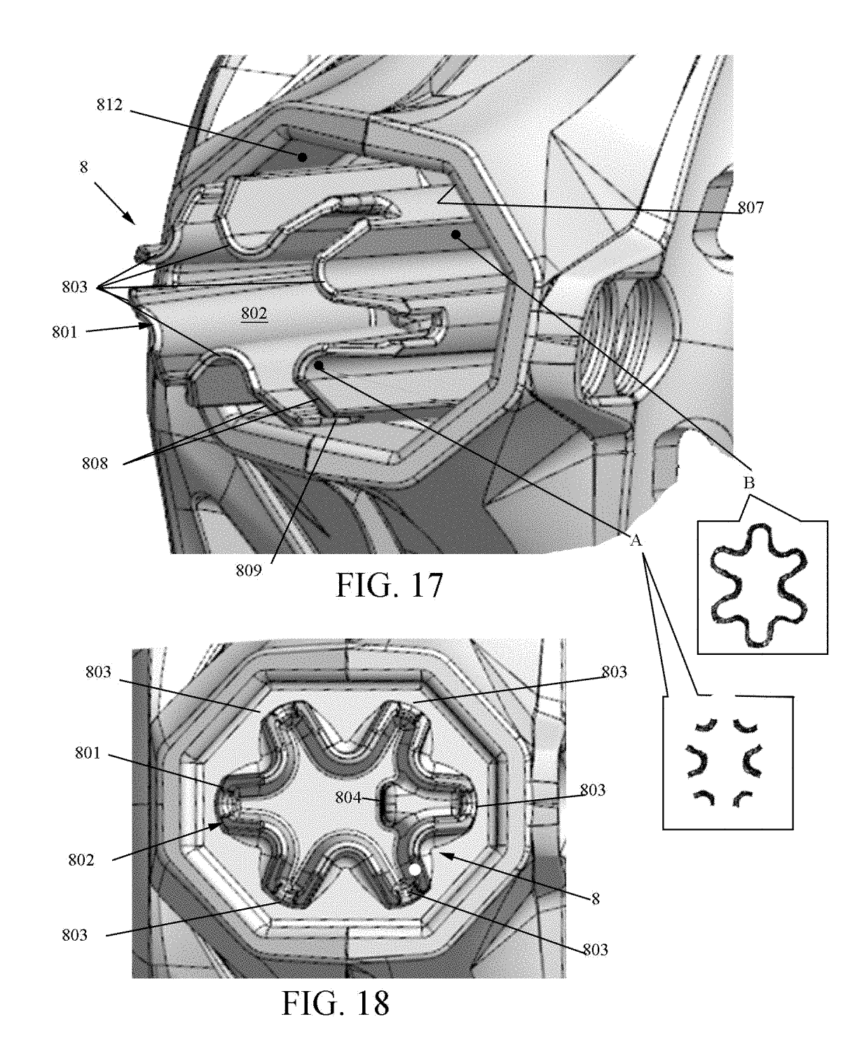

FIGS. 17-19 collectively show several variations of the hexalobe-collared male plug 8 suitable for roughly octagonal-shaped shafts as in FIGS. 13-16. As seen in FIG. 17-18 core 801 has a plurality of radially-protruding compressible members 803, and collar 807 is located around a portion of the length of core 801 and compressible members 803 that creates a gap 812 into which the wall of the shaft slides. Although FIGS. 17-20 illustrate a hexalobe-collared male plug 8 suitable for roughly octagonal-shaped shafts, it should be understood that a collared male plug according to the present invention could be adapted to fit any variety of shaft shapes, such as hexagonal-shaped shafts, tear-drop, asymmetrical, and oval, simply by altering the number of lobes. Indeed, the collared male plug 8 of the present invention could be adapted to accommodate a cylindrical shaft or a shaft having any number of sides.

The illustrated core 801 is defined by a tubular outer wall 802. As seen in FIG. 18 a cross-section of core 801 forms a six-pointed “star” shape (e.g., hexalobe) wherein each point of the star is a lobe, denoted by reference character 803, and functions as a compression point to secure the handle 20 onto head 10A. Again, the preferred dimensions, shapes and material of male core plug 801 and its lobes 803 help maximize the strength of the connection between lacrosse head 10 and shaft 20, and the compressible lobes 803 facilitate a tight friction fit inside shaft 20. In addition, compared to a solid plug fitted into the bore of shaft 20, the compressible lobes 803 and the shape of core plug 801 help reduce the weight so as not to affect the center of gravity of the overall head 10. Collar 807 may be as detailed above, but the collared male plug 8 inclusive of both core 801 and collar 807 according to the present invention may be manufactured in different diameters and/or with different numbers of points as described herein, or may be manufactured in a single, “standard” size and shape designed to be adaptable for use with many of the variations of head and shaft shapes described above. As above one side of the outer wall 802 forming core plug 801 has a greater wall thickness to form an integral screw block 804 (with side screw hole 805 for optional attachment of core plug 801 to handle 20 as described in FIGS. 15 and 16 above).

Referring back to FIG. 17 each of the plurality of compressible members 803 has a chamfered leading edge 808 and a U-shaped notch 809 formed at top. The chamfered leading edge 808 is offset-angled from vertical and this facilitates easier insertion of the core plug 8 into shaft 20. In addition, the chamfered leading edge 808 joins U-shaped notch 809 to add more resiliency at the tips of lobes 803, allowing the tips to flex to a greater degree and reducing stiffness of the core plug 8 at the tip. This again eases insertion and prevents breakage. The U-shaped notch 809 formed at top may range from just a few millimeters to a few centimeters.

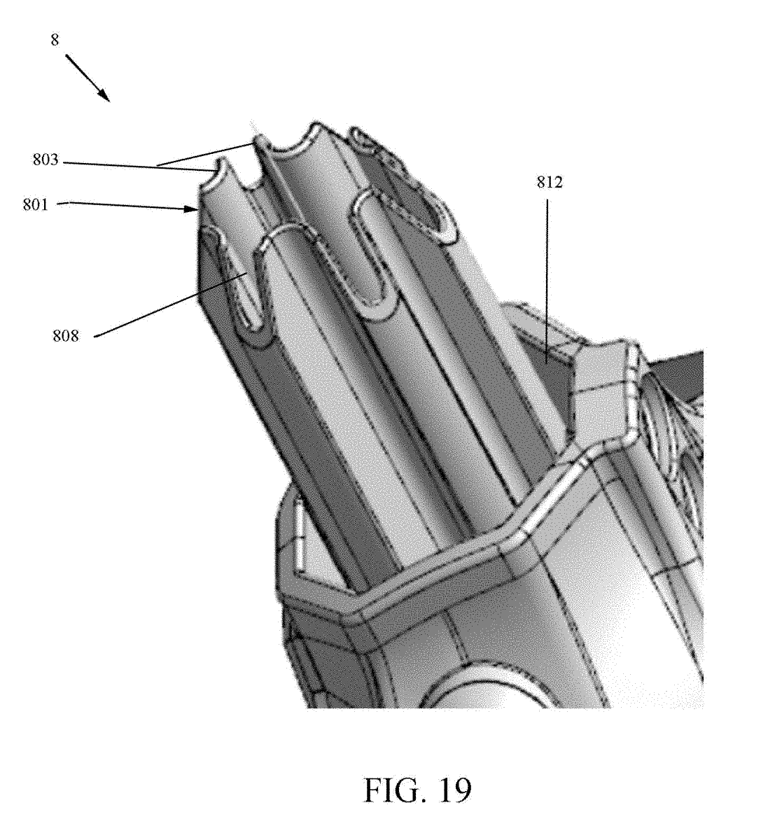

FIG. 19 illustrates these latter variables wherein the chamfer of leading edge 808 is more severe, here approximately 45-60 degrees offset from vertical, which increases depth of separation between opposing walls of each lobe 803 and effectively eliminates the need for U-shaped notch 809 to add more resiliency at the tips of lobes 803. Again the tips of lobes 803 flex by a greater degree and this reduces stiffness of the core plug 8 at the tip. The foregoing may be generalized with reference to the insets of FIG. 17. At a point A at or near the tip of a compressible member 803 anywhere along the chamfered leading edge 808 or U-shaped notch 809, a cross section of core plug 801 taken at point A is discontinuous. Conversely, when taken at point B inwardly of point A (inward of any chamfered leading edge 808 or U-shaped notch 809), the cross section of core plug 801 taken at point B is continuous. The resulting resiliency of the lobes 803 can be defined and controlled by the proportionate size, material selection and taper of each lobe 803.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. A lacrosse head for mounting on a hollow shaft lacrosse stick, comprising:
a frame configured to support a pocket; and
a throat for mounting said lacrosse head on a hollow-shaft lacrosse stick, said throat further comprising a collar projecting outward from said frame for receiving said hollow-shaft lacrosse stick within said collar, and a male core plug projecting coaxially within said collar and protruding outward beyond said collar for insertion inside said hollow-shaft lacrosse stick, said male core plug being sized to leave an annular gap between said collar, said male core plug being bounded by a unitary tubular wall symmetric about an axis and with a ridge-and-furrow profile defining a plurality of compressible lobes extending parallel to said axis and protruding radially for compression-fit within said hollow-shaft lacrosse stick.

2. The lacrosse head according to claim 1, wherein said male core plug protrudes endwise from said throat and axially through said collar so as to form a gap between said male core plug and collar, the number of compressible lobes corresponding to a number of corners of said hollow-shaft lacrosse stick.

3. The lacrosse head according to claim 2, wherein the male core plug protrudes beyond the collar.

4. The lacrosse had according to claim 2, wherein each of the plurality of compressible lobes has a geometric-half profile.

5. The lacrosse head according to claim 4, wherein the unitary wall of the core plug has a substantially star-shaped cross-section.

6. The lacrosse head according to claim 5, further comprising a plurality of compressible strips attached along said core plug distally atop each of said plurality of lobes.

7. The lacrosse head according to claim 2, further comprising one or more screw holes through said collar, said male core plug comprising a corresponding number of screw holes each aligned with a corresponding screw hole in said collar.

8. The lacrosse head according to claim 7, wherein said unitary wall is substantially of uniform nominal thickness with at least one reinforced section of wall having a greater than nominal thickness, and said screw holes penetrate said reinforced section.

9. The lacrosse head according to claim 8, further comprising two reinforced sections of wall having a greater than nominal thickness, and said screw holes penetrate both said reinforced sections.

10. The lacrosse head according to claim 8, wherein said two reinforced sections of wall and said screw holes penetrating both said reinforced sections are angularly offset.

11. The lacrosse head according to claim 1, wherein the core plug has six lobes.

12. The lacrosse head according to claim 1, wherein the core plug has four lobes.

13. The lacrosse head according to claim 1, wherein the core plug has eight lobes.

14. The lacrosse head according to claim 1, wherein said plurality of lobes have beveled edges.

15. The lacrosse head according to claim 1, further comprising a screw anchor block resident inside the core lug said screw block having at least one screw hole.

16. The lacrosse head according to claim 4, wherein said tubular core has a hexalobe cross-section.

17. A lacrosse head for mounting on a hollow shaft lacrosse stick, comprising:
a frame configured to support a pocket;
a throat for mounting said lacrosse head on a hollow-shaft lacrosse stick, said throat further comprising,
a collar projecting outward from said frame for receiving said hollow-shaft lacrosse stick within said collar, and
a male core plug projecting from said throat coaxially within said collar and protruding outward beyond said collar for insertion inside said hollow-shaft lacrosse stick, said male core plug further comprising a hollow tubular wall joined at one end to said throat, having a ridge-and-furrow profile defining a plurality of radially-projecting lobes extending lengthwise to another distal end, and a plurality of resilient fingers projecting coaxially at said other distal end.

18. The lacrosse head according to claim 17, further comprising a gap between said male core plug and collar.

19. The lacrosse head according to claim 17, wherein a number of lobes equals a number of distally-projecting resilient fingers.

20. The lacrosse had according to claim 17, wherein each of the plurality of lobes is compressible.

21. The lacrosse had according to claim 17, wherein each of the plurality of lobes has a curved profile.

22. The lacrosse head according to claim 17, further comprising one or more screw holes through said collar, said male core plug comprising a corresponding number of screw holes each aligned with a corresponding screw hole in said collar.

23. The lacrosse head according to claim 17, wherein said hollow tubular wall is substantially of uniform thickness except for a reinforced section containing said screw holes.

24. The lacrosse head according to claim 17, wherein the core plug has six lobes.

25. The lacrosse head according to claim 17, wherein the core plug has four lobes.

26. The lacrosse head according to claim 17, wherein the core plug has eight lobes.

27. The lacrosse head of claim 17, wherein the hollow tubular wall of said male core has a discontinuous cross-section taken at a first point and a continuous cross-section taken at a second point.

28. The lacrosse head of claim 17, wherein said plurality of resilient fingers taper in thickness from said discontinuous cross-section toward said continuous cross-section.

29. The lacrosse head of claim 17, wherein said plurality of resilient fingers are configured with chamfered leading edges.

30. The lacrosse head of claim 17, wherein the hollow tubular wall of said male core plug is formed with a plurality of notches leading inward from a distal end and defining said discontinuous cross-section.

31. A lacrosse head for mounting on a hollow shaft lacrosse stick, comprising:
a frame configured to support a pocket;
a throat for mounting said lacrosse head on a hollow-shaft lacrosse stick, said throat further comprising a collar projecting outward from said frame for receiving said hollow-shaft lacrosse stick within said collar, and a male core plug projecting coaxially within said collar and protruding outward beyond said collar for insertion inside said hollow-shaft lacrosse stick, said male core plug further comprising a hollow tubular wall having a ridge-and-furrow profile defining a plurality of radially-projecting lobes extending lengthwise to a plurality of resilient fingers projecting distally.

32. The lacrosse head of claim 31, wherein the hollow tubular wall of said male core has a discontinuous cross-section taken at a first point and a continuous cross-section taken at a second point.

33. The lacrosse head of claim 31 wherein said plurality of resilient fingers taper in thickness.

34. The lacrosse head of claim 31, wherein said plurality of resilient fingers are configured with chamfered leading edges.

35. The lacrosse head of claim 31, wherein the hollow tubular wall of said male core plug is formed with a plurality of notches leading inward from a distal end and defining said discontinuous cross-section.

36. The lacrosse head according to claim 31, further comprising a gap between said male core plug and collar.

37. The lacrosse head according to claim 31, wherein a number of lobes equals a number of distally-projecting resilient fingers.

38. The lacrosse had according to claim 31, wherein each of the plurality of lobes has a curved profile.

39. The lacrosse head according to claim 31, wherein the core plug has six lobes.
